(19) United States
(12) Patent Application Publication
(10) Pub. No.: US 2016/0302357 A1
(43) Pub. Date: Oct. 20, 2016

(54) COMBINE HEADER HOOK-UP ASSIST SYSTEM

(71) Applicant: AGCO Corporation, Hesston, KS (US)

(72) Inventors: Steven R. Tippery, Gretna, NE (US); Quentin Guhr, Hillsboro, KS (US)

(21) Appl. No.: 15/101,997

(22) PCT Filed: Nov. 18, 2014
(86) PCT No.: PCT/IB2014/002467

§ 371 Date: Jun. 6, 2016

Related U.S. Application Data
(60) Provisional application No. 61/912,091, filed on Dec. 5, 2013.

(51) Int. Cl. A01D 41/127; A01B 59/06

(52) U.S. Cl. CPC A01D 41/127; A01B 59/061

(57) ABSTRACT

A system including a detachable header a target area; and a combine harvester with a feeder house configured to couple to the detachable header in an area corresponding to the target area; and a control system that can detect the target area; automatically cause the feeder house to align with the target area; and responsive to the alignment, cause automated coupling of the feeder house with the detachable header in the area corresponding to the target area.

### TECHNICAL FIELD

The present disclosure is generally related to machines with detachable implements and, more particularly, systems and methods for attaching implements to machines.

### BACKGROUND

Machines in many industries often use manually-detachable implements to facilitate certain operational and/or transport features and/or to provide a choice among varied functionality for a given machine. For instance, a snowplow may be manually coupled to a dump truck during winter seasons, while operation occurs without the snowplow during other seasons. Also, one type of excavator bucket may be switched out for another for a given excavator machine depending on the excavated material and/or terrain. In the agricultural industry, a corn header may be coupled to a combine harvester for harvesting corn in one instance, and replaced with a header that facilitates wheat harvesting in other instances. Further, transport along standard roads may also motivate the detachment of the implements, depending on the size of the machine with implement attachment. For instance, in the case of combine harvesters, the headers are very wide, and are not compatible with circulation on most roads. The most common method to transport the header from field to field is to detach the header from the combine harvester and use a trailer to transport the header.

Regardless of the industry or machine, attaching and detaching the implement consumes time and resources, where the operator often needs to leave the cab of the machine several times or utilize cooperation with another person for providing assisted direction to complete the operations.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram, in front elevation view, of an example combine harvester with a header attached according to an embodiment of a header hook-up assist system.

FIG. 2 is a schematic diagram, in enlarged perspective view, of a combine harvester feeder house without a coupled header.

FIG. 3A is a schematic diagram, in truncated rear-perspective view, of a target area of a header that is to be aligned with the front of the feeder house in an embodiment of a header hook-up assist system.

FIG. 3B is a schematic diagram, in side elevation view, of certain features of the header that enables the coupling between the feeder house and the header by an embodiment of a header hook-up assist system.

FIGS. 4A-4D are block and schematic diagrams of a combine harvester as it is automatically oriented along one or more directions by an embodiment of a header hook-up assist system to align the feeder house with a target area of the header and achieve coupling.

FIGS. 5A-5B are block diagrams that illustrate an embodiment of a control system including a controller for an embodiment of a header hook-up assist system.

FIG. 6 is a flow diagram that illustrates an embodiment of a header hook-up assist method.

### DESCRIPTION OF EXAMPLE EMBODIMENTS

### Overview

In one embodiment, a system, comprising: a detachable implement comprising a target area; and a machine comprising: a portion configured to couple to the detachable implement in an area corresponding to the target area; and a control system configured to: detect the target area; automatically cause the portion to align with the target area; and responsive to the alignment, cause automated coupling of the portion with the detachable implement in the area corresponding to the target area.

### Detailed Description

Certain embodiments of a header hook-up assist system and method are disclosed that automate implement-coupling operations for a machine. In one embodiment, the header hook-up assist system includes a control system comprising a controller and one or more sensors on the machine (and in some embodiments, the header). The sensors may detect a target area of the detached implement, as well as a portion of the machine that couples to the implement. Resultant signaling from the sensors is fed to the controller, which controls navigation of the machine and, in some embodiments, controls movement of portions of the machine that are independent of the movement corresponding to navigation of the machine. The controller, responsive to the sensor signals, autonomously (e.g., independent of operator intervention) causes machine navigation movement (and/or portions thereof) to align or orient the machine portion that couples to the implement with the implement and ultimately, causes the autonomous mechanical coupling between the target area and the portion of the machine that couples to the target area.

In contrast, current systems for coupling detachable implements are manually intensive, which may increase the time of implementing such operations as well as cause an inconvenience for the operator and/or his or her helper. In addition, current systems are unsuitable for autonomous operations, which for industries like the agricultural industry, may render a farmer less competitive when considering time and/or labor savings possible for fully autonomous or even semi-autonomous systems.

Having summarized certain features of header hook-up assist systems of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on a combine harvester for the agricultural industry, though it should be appreciated within the context of the present disclosure that other machines that use detachable implements of the same or different type, for the same or different industries, are contemplated to be within the scope of the present disclosure. For instance, certain embodiments of a header hook-up assist system may be used to automatically couple a skid steer loader, wheel loader, or excavator to a bucket, or automatically couple a truck or tractor to a snowplow, among other machines, implements, and/or industries. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the combine harvester looking forwardly. Also, certain embodiments of header hook-up assist systems described herein focus on the detection of target areas of the implement (e.g., header) and the contact area of the machine (e.g., a portion of the machine, such as the feeder house front-end portion or face), orientation of the machine and/or machine portion (e.g., alignment), and the mechanical coupling or engagement between the implement and the portion of the machine to enable simple operational movement of the implement under the control of the machine, such as controlled lifting of the implement by the machine. The actuation of drives (e.g., hydraulic, electrical, etc.), such as to power and/or control cutting and/or gathering mechanisms in the implement are not covered in this disclosure. Autonomous attachment and/or detachment that includes automated coupling of the header drive mechanisms may be found in commonly-assigned patent application entitled, “Automatic Header Coupling,” having attorney docket number P1408H, filed on Jul. 23, 2013.

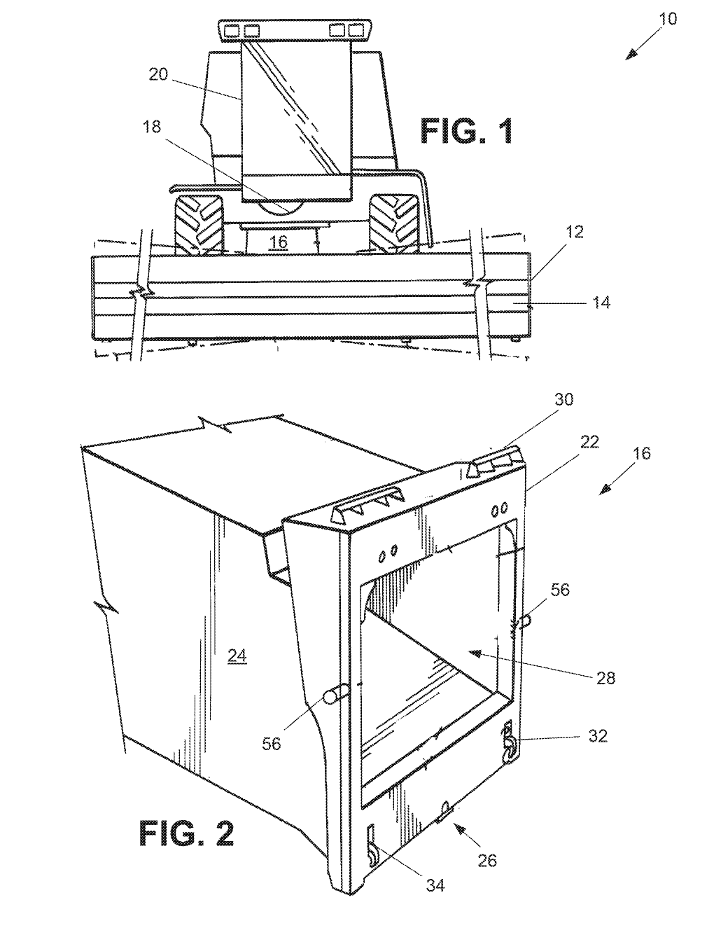

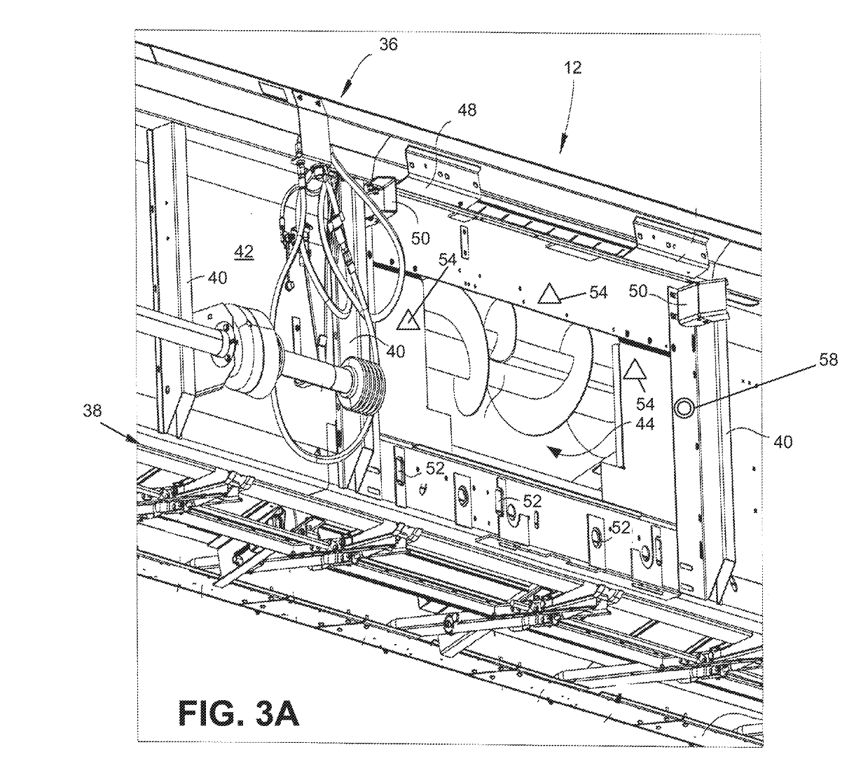

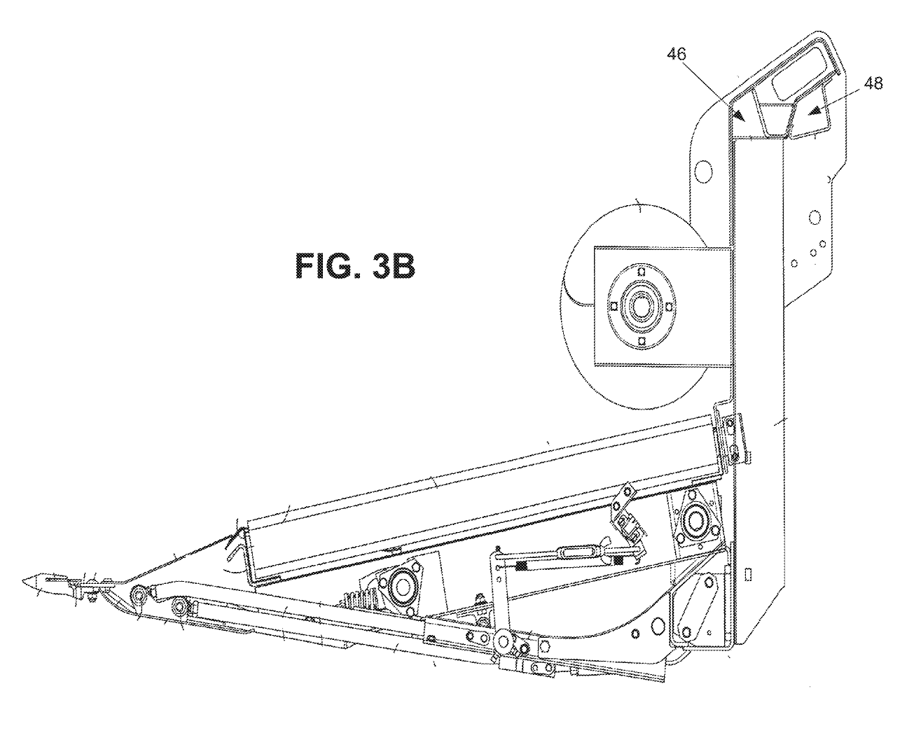

Referring now to FIG. 1, shown in front elevation view is an example machine, in this case, a combine harvester 10 (hereinafter, simply “combine”), with an implement, configured in this example as a header 12 (shown truncated), attached. It should be understood by one having ordinary skill in the art, in the context of the present disclosure, that the example combine 10 shown in FIG. 1 is merely illustrative, and that other combine configurations or other machines may be implemented in some embodiments. In the example embodiment depicted in FIG. 1; the header 12 is configured as a crop cutter/feeder type header 12. The header 12, which is largely conventional (except for the application of one or more sensors, as described below), includes a reciprocating cutter bar 14 for cutting off the crop and feeding it via an auger type feeder (not shown, though illustrated in FIG. 3A) to a feeder house 16. The feeder house 16 functions in part as an independently-moveable portion of the combine 10. For instance, though the feeder house 16 moves correspondingly relative to the traversed terrain with the navigational movement of the combine 10, known cylinder(s) located beneath the feeder house 16 may be actuated by a controller of the combine 10 to raise and lower the feeder house 16, and a cylinder(s) (not shown in FIG. 1) may be actuated by the controller to cause a tilt assembly of the feeder house 16 to roll relative to an axis running longitudinally through the feeder house 16. Such movements of the feeder house 16 not only facilitate the alignment of the feeder house 16 with a target area of the header 12, but also enable the header 12 to more closely follow the contours of the ground during operations. For instance, to cut the grain crop at a consistent height, the tilt assembly of the feeder house 16 enables the header 12 to be selectively tiltable laterally relative to the combine 10 to thereby follow the contours of the ground over which the combine 10 operates. This function is shown schematically in FIG. 1, where the header 12 is shown in solid lines in a horizontal position, and, alternatively, in dashed lines laterally tilted to the left and right. From the feeder house 16, the cut crop is fed into the combine 10, with the grain being threshed and separated therein from the plant residue in a known manner. For purposes of simplicity, all of the feeding mechanisms of the feeder house 16 have been eliminated from the drawings.

Also shown in FIG. 1 is a sensor 18 mounted on the combine 10. In this example, the sensor 18 is located beneath a cab 20 of the combine 10, centered laterally over the feeder house 16. In some embodiments, the sensor 18 may be mounted on other locations on the combine 10 (e.g., on the feeder house 16, on the top of a cab 20 of the combine 10, in the rear of the combine 10 for rear-coupled implements, etc.). In some embodiments, there may be a plurality of sensors 18 located on the combine 10. In some embodiments, there may be one or more sensors of the same or different type located on the header 12, as described below. In one embodiment, the sensor 18 may be configured as a moving image or still image type, image capture device, operational in one of a plurality of electromagnetic wavelengths (e.g., visible spectrum or non-visible spectrum, such as the infrared, ultraviolet, ultrasonic, among other ranges). In one embodiment, the sensor 18 is embodied as a stereoscopic camera. For instance, the sensor 18, when embodied as a stereoscopic camera, may image an outline of the feeder house front portion and a target area of the header 12, and provide the image signals to a controller of the combine 10 for further processing (e.g., triangulation, signal conditioning, etc.), wherein the controller responsively enables (through interaction of various machine controls) controlled, autonomous alignment (e.g., where their respective longitudinal center axes align) between the feeder house opening and the target area to facilitate coupling.

In some embodiments, the sensor 18 may be a non-stereoscopic camera (e.g., used alone or with one or more other cameras) to perform feature recognition, or used with one or more other cameras that provide output signals of that are processed by a controller of the combine 10 to produce stereoscopic images (e.g., through use of a point cloud in known manner) and processing of the stereoscopic images (e.g., triangulation, signal conditioning, etc.). As an example of the former, targets and/or special features in and/or around the target area of the header 12 may be imaged by the cameras to identify spatial relationships, depths, etc., enabling the alignment and subsequent coupling between the feeder house 16 and the header 12 based on triangulation of coordinate points pertaining to the features of the target area and the feeder house 16.

In some embodiments, the sensor 18 may be configured as a non-imaging sensor, such as a Bluetooth sensor (e.g., positioning sensor), that is used in conjunction with additional sensors located on the combine 10 and the header 12 to enable autonomous positioning of combine 10 and the header 12 to facilitate coupling between the two components. For instance, the sensor 18 (e.g., mounted on the combine 10) in cooperation with a controller of the combine 10, may process the signals (e.g., signal strength parameters, such as RSSI readings or variations of the same) from plural Bluetooth sensors located on the header 12 and triangulate the position of the header 12 relative to the combine 10. In some embodiments, the targets or special features may be embodied as RFID, QR, or bar codes, or similar technology, that are coded with coordinates and that enable a determination of the target area. The sensor 18 may be configured as an RF or QR or bar code reader that; in cooperation with a controller on the combine 10, determines the depth and location (e.g., through triangulation) of the target area relative to the feeder house 16 for guiding the coupling between the feeder house 16 and the target area of the header 12. In some embodiments, one or more additional sensors mounted on the combine 10 may be used to provide a location for the combine 10, such as a positioning or guidance system or sensor(s) (e.g., global navigation satellite system (GNSS), such as GPS, GLONASS, etc.), where the coordinates of the feeder house location is based on the continually updated positioning coordinates and an internally programmed distance parameter(s) corresponding to the location of the positioning sensor relative to the position coordinates of the face or other features of the feeder house 16.

Referring to FIG. 2, shown is a perspective front view of an embodiment of the feeder house 16, the feeder house 16 comprising a lateral tilt assembly 22 at the front portion of the feeder house 16. The lateral tilt assembly 22 rolls about an axis coincident with a fixed frame 24 (e.g., housing) and the lateral tilt assembly 22 that surrounds the face of the feeder house 16. In one embodiment, a pivot point 26 for the rolling movement is centered at the bottom of the lateral tile assembly 22, though not limited to that location or quantity. The rolling movement is based on a known assembly of a hydraulic piston/cylinder unit and clevis in cooperation with one or more rollers and roller tracks mounted behind the face (e.g., top face) of the lateral tilt assembly 22. Additional details of an example of a lateral tilt assembly may be found in commonly assigned U.S. Pat. No. 5,918, 448, though other structures or mechanisms to enable the rolling movement of the lateral tilt assembly 22 may be used and hence are contemplated to be within the scope of the disclosure. Note that reference to “fixed” in fixed frame 24 is in terms of rolling movement, as one or more cylinders coupled to the frame of the combine 10 and the bottom of the fixed frame 24 enable the feeder house 16 to be raised and lowered by a control system of the combine 10 as needed to orient or align with a target area of the header 12. Cut crop material enters from the header 12 into an opening 28 defined by the front face of the feeder house 16.

Disposed at the top of the lateral tilt assembly 22 is a pair of upstanding header retaining protrusions 30 which extend upward from the top surface of the lateral tilt assembly 22. The lateral tilt assembly 22 also includes a pair of rotating header hooks 32 which extend outward through respective slots 34 in a front face of the lateral tilt assembly 22 to mechanically couple the header 12 to the feeder house 16. In short, the automated coupling involves at least the upstanding header retaining protrusions 30 becoming engaged with an upper lip of the header 16 corresponding to the target area and the rotating header hooks 32 rotated during the coupling such that sockets in the header 12 can be attached to the frame of the lateral tilt assembly 22 and removed from the frame.

Referring now to FIG. 3A, shown is an example header 12 that is coupled to the feeder house 16 (FIG. 2) of the combine 10 (FIG. 1). It should be appreciated that, though a Draper-style header 12 is shown, other configurations of headers, or other detachable implements, may be used and hence are contemplated to be within the scope of the disclosure. The header 12 depicted in FIG. 3A comprises a frame at the rear thereof that includes an upper beam assembly 36 extending across the entire width of header 12, and a lower beam assembly 38 that likewise extends across the full width of header 12. A number of upright channels 40 interconnect the beam assemblies 36, 38 across the backside of the header 12 at spaced locations thereacross. Upright rear panels 42 on the front sides of the channels 40 define an upright rear wall of the header 12, while a centrally located opening 44 in such panels 42 serves as a crop outlet from the header 12 to the feeder house 16 of the combine 10. In one embodiment, and referring to FIGS. 3A and 3B, the upper beam assembly 36 is provided with downwardly opening mounting pockets 46 or lips (FIG. 3B) that are adapted to matingly receive corresponding upwardly projecting header retaining protrusions 30 (FIG. 2) on the lateral tilt assembly 22 (FIG. 2) of the feeder house 16. Rests 48 on the upper beam assembly 36 are disposed rearwardly adjacent the pockets 46 for engaging top surface structures on the feeder house 16 to assist in supporting the header 12 on the combine 10. A pair of rearwardly projecting guides 50 (FIG. 3A) are disposed adjacent the rests 48 and slightly outboard therefrom for embracing opposite sides of the feeder house 16 and aligning the central opening 44 with the face of the feeder house 16. Multiple sets of receiving sockets 52 are disposed below the central opening 44 in association with the lower beam assembly for receiving the rotating header hooks 32 (FIG. 2) of the lateral tilt assembly 22 of the feeder house 16 in an arrangement that depends upon the particular brand of combine to which header 12 is mounted.

In one embodiment, the target area may be defined by the central opening 44. As described above, in one embodiment, the sensor 18 (FIG. 1) of the combine 10 may recognize the central opening 44 through stereoscopic imaging, and guide the alignment and ultimate coupling between the feeder house 16 and the header 12 in a coupling area corresponding to the target area, the area having the central opening 44 centrally located. In some embodiments, a plurality of sensors 54 (e.g., three (3) shown in the depicted example, schematically shown as triangles) may be positioned at the border of a target area, such as adjacent three (3) sides of the central opening 44, and used by the sensor 18 mounted on the combine 10 in conjunction with a controller of the combine 10 to enable automated guidance and coupling between the coupling area corresponding to the target area and the feeder house 16. In some embodiments, other portions of the header 12 may be used to define a target area.

In some embodiments, an engagement feedback sensor may be used to confirm to a controller of the combine 10 the successful mechanical coupling between the header 12 and the feeder house 16 (FIG. 2). In one embodiment, and referring again to FIGS. 2-3, a pair of pins 56 or other members may extend from the sides of the lateral tilt assembly 22, and when coupling is achieved between the header 12 and the feeder house 16, the pair of pins 56 seat into respective receptacles 58 (one shown schematically in FIG. 3A). Though shown schematically in FIG. 3 as a round receptacle, other geometric configurations may be used and hence are contemplated to be within the scope of the disclosure. In addition, though the receptacles and pins are depicted in example locations in FIGS. 2 and 3A, other locations on the header 12 and feeder house 16 may be used, and hence are contemplated to be within the scope of the disclosure. A sensor, such as a potentiometer, among other types of sensors detecting contact or force, may be attached to, or built into, the receptacles 58 (or located proximally to the pin or pins 56 on the feeder house 16 in some embodiments). Upon activation of the sensor of the receptacle 58 (e.g., based on force applied by the pins 56 depressing the sensors in the receptacles 58 during successful coupling), a feedback signal may be communicated wirelessly (e.g., via a Bluetooth protocol, radio frequency transmission, among others), or in some embodiments, over a wired medium, to a controller of the combine 10, providing a confirmation of the coupling to the controller (which may also be presented on a screen display to an operator in some embodiments). It should be appreciated that other mechanisms for detecting the coupling, either of a contact or non-contact nature, may be used to provide feedback to a controller of the combine 10.

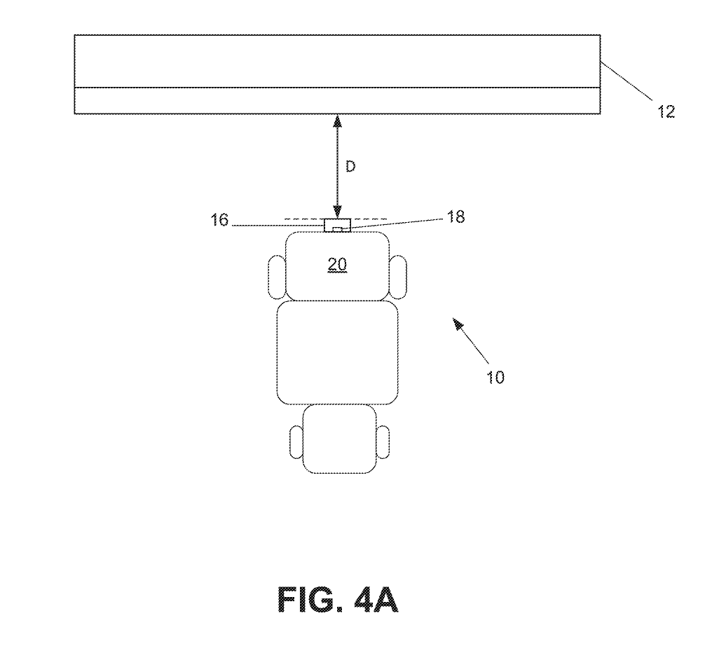

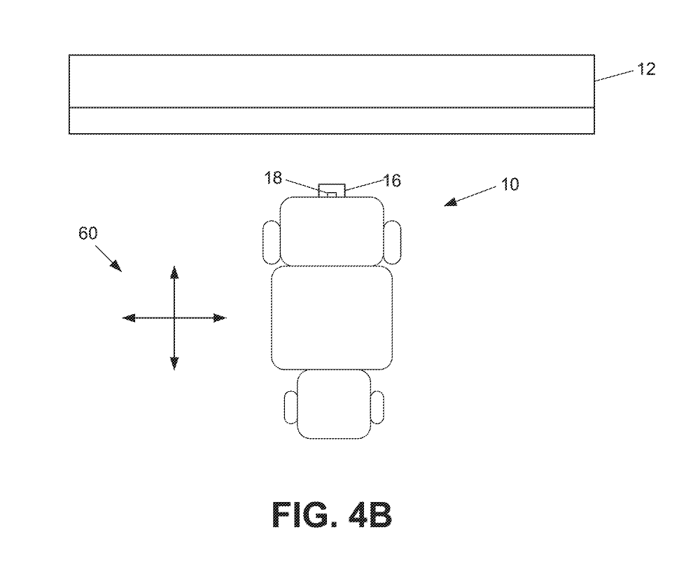

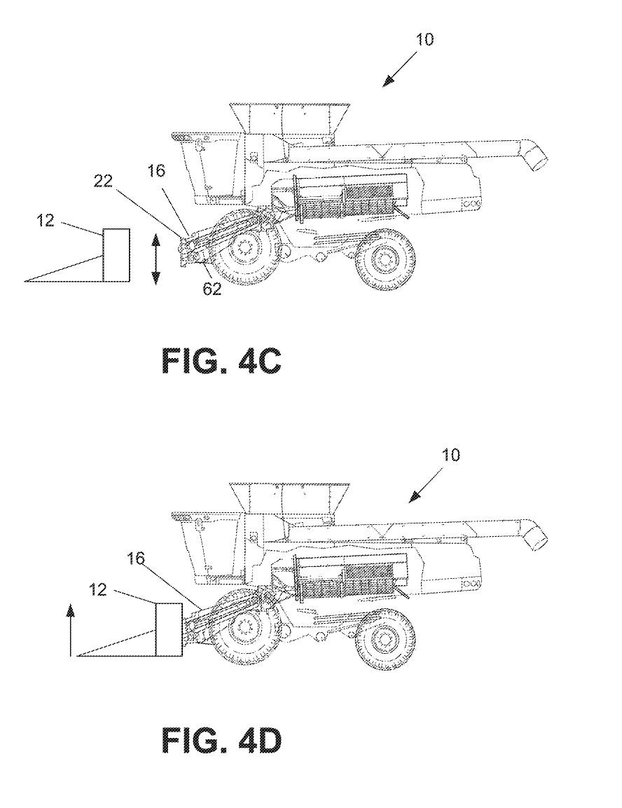

Referring now to FIGS. 4A-4D, shown are block and schematic diagram illustrations of an embodiment of a header hook-up assist method. It should be appreciated within the context of the present disclosure that the method illustrated in FIGS. 4A-4D are merely illustrative, and that other methods of automated coupling may be used and hence are contemplated to be within the scope of the disclosure. In FIG. 4A, shown is the combine 10 without the header 12 attached. Navigation of the combine 10 may be under the control of an operator located in the cab 20, or located elsewhere (e.g., remotely). In one embodiment, the operator navigates the combine 10 to a (or within a) predetermined distance, D (e.g., within 10 feet, as one non-limiting example), from the header 12. The operator preferably orients the combine 10 in a manner that facilitates automated coupling with the header 12 without an undue amount of lateral movement relative to the header 12. At or around the predetermined distance, the operator activates the header hook-up assist system. The activation may be in the form of a verbal communication to a user interface coupled to a controller of the combine 10, such as via a headset or a microphone located on a user interface panel located in the cab 20. In some embodiments, activation may be via a touch-screen display or selection of a function via mouse or other input device with a corresponding selection verified on a screen display. In some embodiments, activation may be via user manipulation of a joystick, or switch located thereon, or via a panel switch (e.g., button, lever, etc.) within the cab 20. For remote operator interaction, activation may be via a wireless signal (e.g., RF, cellular, etc.) communicated to a communications interface of the controller of the combine 10.

Upon activation, the controller of the combine 10 may activate the sensors of the combine 10, such as sensor 18, as well as take command (e.g., release the operator's control) of various controls of the combine 10, such as navigational control (e.g., controlling the navigational movement of the combine) and sub-system control (e.g., actuators responsible for activating the cylinder(s) that raises and lowers, the feeder house 16, actuators that control the cylinder(s) that control the lateral tilt assembly 22 (FIG. 2), etc.). In one embodiment, the controller of the combine 10 causes the capture of a sequence of images of the header 12 and feeder house 16 by the sensor 18 and, responsive to signals from the sensor 18, activates the necessary directional movement of the combine 10, as illustrated in FIG. 4B by the multi-directional arrows 60. The capture of the sequence of images includes the imaging of a target area of the header 12 and the feeder house 16 to determine coordinates of the same to enable alignment before coupling. In some embodiments, additional signaling may be used, such as guidance-sourced positioning signals from a GPS or like receiver located on the combine 10 to permit a coordinate basis of the combine 10 and/or the header 12. As the controller of the combine 10 causes the combine 10 to close the distance to the header 12, the controller may also activate one or more sub-systems to align the height of the feeder house opening relative to the target area of the header 12. For instance, as shown in FIGS. 4C and 4D, the controller may activate the cylinder 62 to raise or lower the feeder house 16 in an effort to align the feeder house opening with the target area of the header 12. Another sub-system activated may be the lateral tilt assembly 22, such as if the terrain upon which the combine 10 rests and/or the terrain or trailer upon which the header 12 rests is uneven. In some embodiments, other sub-systems may be actuated by the controller during the alignment and/or orientation phase of the process, such as raising or lowering the chassis. Upon coupling between the header 12 and the feeder house 16 of the combine 10, feedback of the mechanical coupling may be received by the controller of the combine 10, as described above. At this point, the header 12 may be raised from its rest position, either autonomously, or via operator control; in one embodiment the raising signifying respectively continued autonomous operations of the combine 10 or termination of the header hook-up assist process and the returned control of the combine 10 to the operator.

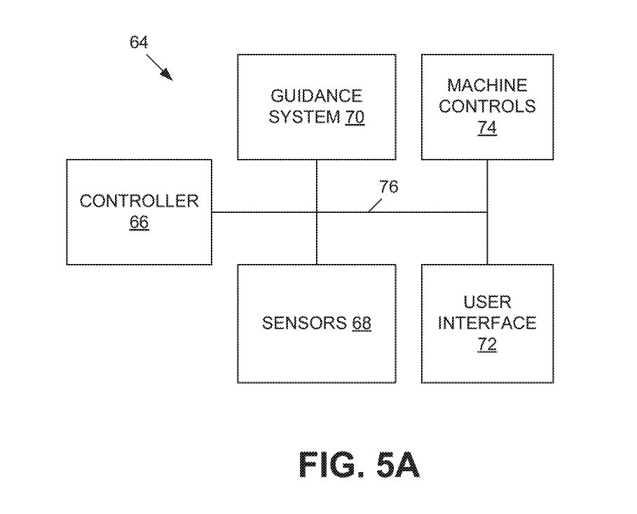

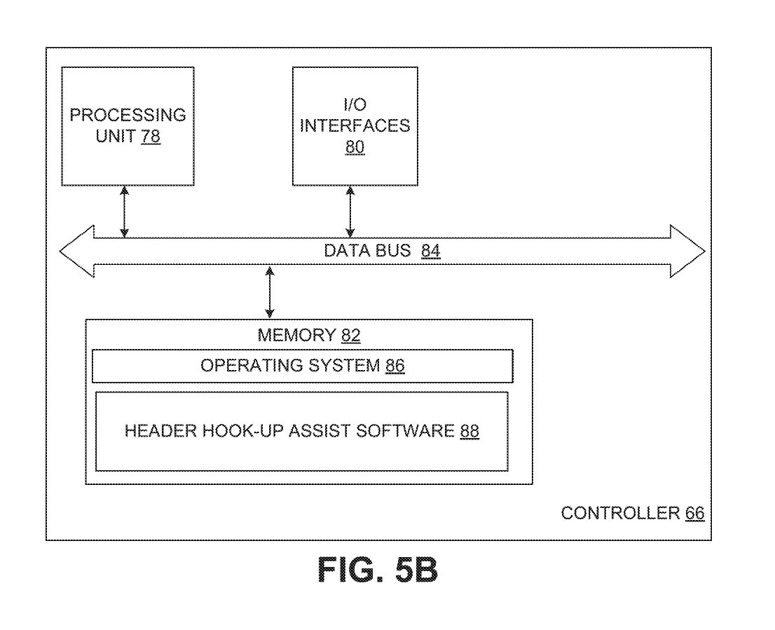

FIG. 5A shows an embodiment of a control system 64 for an embodiment of a header hook-up assist system. In one embodiment, the header hook-up assist system comprises the control system 64 or a subset thereof. It should be appreciated within the context of the present disclosure that some embodiments may include additional components or fewer or different components, and that the example depicted in FIG. 5A is merely illustrative of one embodiment among others. The control system 64 includes a controller 66, sensors 68, an auto-guidance system 70 (herein, also simply “guidance system”), a user interface 72, and machine controls 74, each coupled to one another via a network 76. In some embodiments, multiple controllers 66 may be used. The controller 66 may be coupled in a CAN network 76 (though not limited to a CAN network or a single network) to the sensors 68, guidance system 70, user interface 72 and the machine controls 74. The sensors 68 collectively comprise the sensors 18, header sensors 54, cab occupancy sensors, and/or feedback sensors, among others. The guidance system 70 may include devices (e.g., receivers) for a global navigation satellite system (GNSS), such as global positioning systems (GPS), GLONASS, Galileo, among other constellations. The user interface 72 may be a keyboard, mouse, microphone, touch-type display device, head-set, or other devices (e.g., switches) that enable input by an operator (e.g., such as while in the operator cab 20 (FIG. 1)). The machine controls 74 collectively comprise the various actuators, cylinders, and/or controlled devices residing on the combine harvester 10 (FIG. 1) and associated with various sub-systems, such as sub-systems responsible for controlling machine navigation (e.g., speed, direction, etc.), internal machinery operations (e.g., for processing system adjustments, cleaning system adjustments, etc.), feeder house up and down movement, tilt frame rotational movement, chassis height and/or width control, among others functions.

In some embodiments, the controller 66 provides for the overall management and control of the control system 64, and in some embodiments, two or more of the components (e.g., separate components of machine controls 74) may communicate with each other (e.g., in peer-to-peer relationship) without intervention by the controller 66.

In one embodiment, the controller 66 receives input from an operator in the cab 20 (FIG. 1) via the user interface 72, such as to navigate the combine 10 (FIG. 1) to a (or within a) predetermined distance from the header 12 (FIG. 1). In some embodiments, the guidance system 70 may replace operator intervention in navigating the combine 10 to a (or within) predetermined distance from the header 12, after which the header hook-up assist system takes control of the coupling phase of autonomous operations. The signals from the sensors 68 are received by the controller 66, which in turn sends signals to the machine controls 74 to directly or indirectly (e.g., through an intermediary device(s) or controller) cause changes in the movement (e.g., speed and/or direction) of the combine 10 and/or changes in the movement of a portion of the combine 10, such as changes to the height of the feeder house 16 and/or the tilt of the lateral tilt assembly 22 (FIG. 2).

In some embodiments, an external communication may prompt the automated coupling process, such as where the sensors 68 communicate signals to the controller 66, which in turn communicates over a wireless network via a communications interface to a remote server (e.g., directly or indirectly, such as via a base station, or cellular network) for processing of the signals and return of the necessary navigational and/or sub-system adjustments to guide the combine 10 (FIG. 1) to the header 12 (FIG. 1) for subsequent mechanical coupling. In some embodiments, the automated header hook-up assist process may be monitored in real-time on a screen display in the cab 20 (FIG. 1), or remotely, to enable operator intervention in timely fashion should the need arise for the operator to take control of the combine 10.

FIG. 5B further illustrates an example embodiment of the controller 66. One having ordinary skill in the art should appreciate in the context of the present disclosure that the example controller 66 is merely illustrative, and that some embodiments of controllers may comprise fewer or additional components, and/or some of the functionality associated with the various components depicted in FIG. 5B may be combined, or further distributed among additional modules, in some embodiments. The controller 66 is depicted in this example as a computer or computing device, but may be embodied as a programmable logic controller (PLC), FPGA, among other devices. It should be, appreciated that certain well-known components of computers are omitted here to avoid obfuscating relevant features of the controller 66. In one embodiment, the controller 66 comprises one or more processors or processing units, such as processing unit 78, input/output (I/O) interface(s) 80, and memory 82, all coupled to one or more data busses, such as data bus 84. The memory 82 may include any one or a combination of volatile memory elements (e.g., random-access memory RAM, such as DRAM, and SRAM, etc.) and nonvolatile memory elements (e.g., ROM, hard drive, tape, CDROM, etc.). The memory 82 may store a native operating system, one or more native applications, emulation systems, or emulated applications for any of a variety of operating systems and/or emulated hardware platforms, emulated operating systems, etc., In the embodiment depicted in FIG. 5B, the memory 82 comprises an operating system 86 and header hook-up assist software 88. It should be appreciated that in some embodiments, additional or fewer software modules (e.g., combined functionality) may be employed in the memory 82 or additional memory. In some embodiments, a separate storage device may be coupled to the data bus 84, such as a persistent memory (e.g., optical, magnetic, and/or semiconductor memory and associated drives).

With reference to FIGS. 5A and 5B hereinafter, the header hook-up assist software 88 receives information (sensor signals, and in some embodiments, other signals such as guidance signals) from the sensors 68 and processes the signals to derive coordinates (absolute or relative) of the feeder house 16 and a target area of the header 12. Processing may include feature recognition, edge detection, among other well-known image object identification methods and/or functions. Processing may also involve a determination and/or averaging of signal strength values (e.g., RSSI), triangulation for coordinate determinations, RFID, OR, and/or bar code scanning and decoding, among other processes. The header hook-up assist software 88 derives coordinate adjustments for delivery to the machine controls 74 to enable adjustments in movement (e.g., the speed, direction, height, and/or angle) of the combine 10 or portions thereof relative to the header 12. It should be appreciated that other machine operation software may be included in the memory 82 in some embodiments, such as automated field traversal guidance software.

Execution of the header hook-up assist software 88 is implemented by the processing unit 78 under the management and/or control of the operating system 86. In some embodiments, the operating system 86 may be omitted and a more rudimentary manner of control implemented. The processing unit 78 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 66.

The I/O interfaces 80 provide one or more interfaces to the network 76 (and/or other networks, such as cellular, WiFi, RF, etc.). In other words, the I/O interfaces 80 may comprise any number of interfaces for the input and output of signals (e.g., analog or digital data) for conveyance over one or more networks, including network 76. The input may comprise input by an operator (local or remote) through the user interface 72 (e.g., a keyboard or mouse or other input device (or audible input in some embodiments)), and input from signals carrying information from one or more of the components of the combine harvester 10 (FIG. 1), such as machine controls 74, sensors 68, guidance system 70, among other devices.

When certain embodiments of the controller 66 are implemented at least in part with software (including firmware), as depicted in FIG. 5B, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the controller 66 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

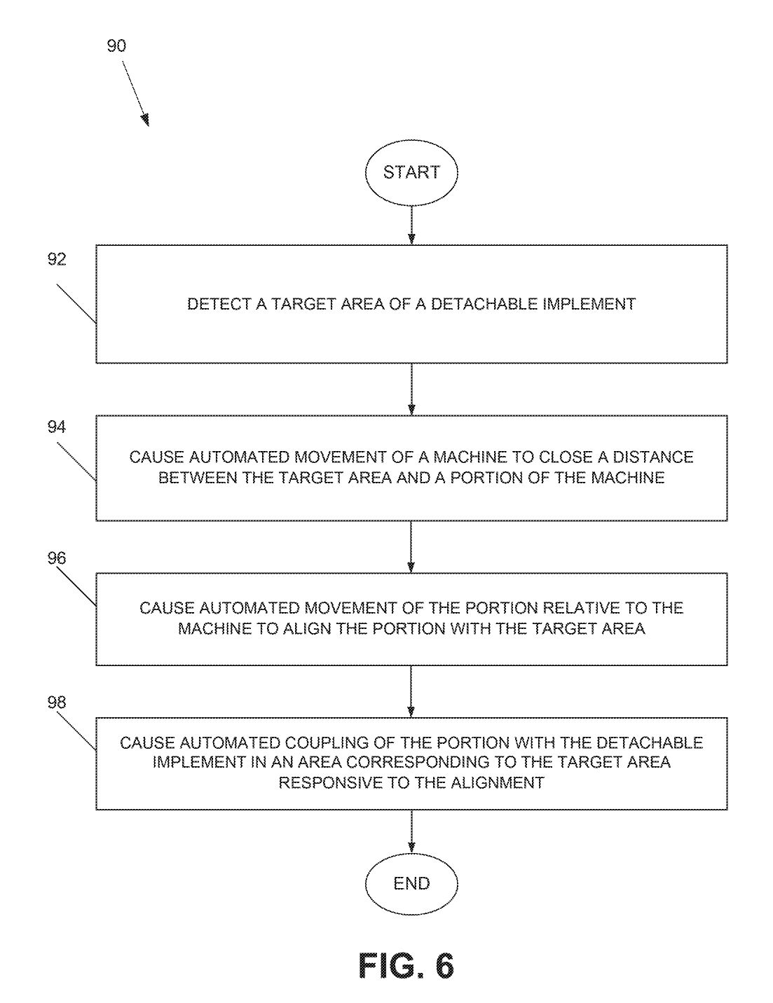

Having described certain embodiments of a header hook-up assist system and method, it should be appreciated within the context of the present disclosure that one embodiment of an header hook-up assist method, denoted as method 90 and illustrated in FIG. 6, comprises detecting a target area of a detachable implement (92); causing automated movement of a machine to close a distance between the target area and a portion of the machine (94); causing automated movement of the portion relative to the machine to align the portion with the target area (96); and causing automated coupling of the portion with the detachable implement in an area corresponding to the target area responsive to the alignment (98).

Note that in some embodiments, the method 90 is not implemented (or in some embodiments, only a portion is implemented, such as detecting) unless the controller 66 (FIG. 5B) detects (e.g., via signaling from an occupancy sensor located in the cab 20 (FIG. 1)) the presence of the operator in the cab 20.

Any process descriptions or blocks in flow diagrams should be understood as representing steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

1. A method, comprising:
detecting a target area of a detachable header;
causing automated movement of a combine harvester to close a distance between the target area and a feeder house of the combine harvester;
causing automated movement of the feeder house relative to the combine harvester to align the feeder house with the target area; and
causing automated coupling of the feeder house with the detachable header in an area corresponding to the target area responsive to the alignment.

2. The method of claim 1, wherein causing automated coupling further comprising enabling a lifting of the detachable header.

3. The method of claim 2, wherein the lifting is an automated lifting.

4. The method of claim 1, further comprising:
causing the combine harvester to move within a defined distance from the detachable header based on a first operator input; and
receiving a second operator input, the second operator input enabling the automated movement of the combine harvester and the automated movement of the feeder house.

5. The method of claim 4, wherein the first and second operator inputs are sourced from a device located remotely from the combine harvester.

6. The method of claim 4, wherein causing automated movement of the combine harvester, automated movement of the feeder house, and automated coupling are further based on detecting an operator in a cab of the combine harvester.

7. The method of claim 1, wherein detecting, causing the automated movement of the combine harvester and the feeder house, and causing the automated coupling are based on Bluetooth technology.

8. The method of claim 1, wherein detecting, causing the automated movement of the combine harvester and the feeder house, and causing the automated coupling are based on stereoscopic camera technology.

9. The method of claim 1, wherein detecting, causing the automated movement of the combine harvester and the feeder house, and causing the automated coupling are based on feature recognition technology.

10. The method of claim 1, further comprising receiving feedback confirming the automated coupling of the feeder house with the detachable header in the area corresponding to the target area.

11. A system, comprising:
a detachable header comprising a target area; and
a combine harvester comprising:
a feeder house configured to couple to the detachable header in an area corresponding to the target area; and
a control system configured to:
detect the target area;
automatically cause the feeder house to align with the
target area; and
responsive to the alignment, cause automated coupling of the feeder house with the detachable header in the area corresponding to the target area.

12. (canceled)

13. The system of claim 11, wherein the target area comprises a central opening in the header with a lip, and the feeder house supporting the header at the lip when the header is coupled to the feeder house.

14. The system of claim 13, wherein the control system comprises a stereoscopic camera mounted to the combine harvester and configured to detect the target area and an opening of the feeder house, the control system further configured to guide movement of the combine harvester, the feeder house, or a combination of both based on processing signals received from the stereoscopic camera to cause coupling of the target area with the feeder house with central axis alignment maintained between the opening of the feeder house and the central opening of the header.

15. The system of claim 13, wherein the control system comprises Bluetooth sensors mounted to the combine harvester and the header, the control system further configured to guide movement of the combine harvester, the feeder house, or a combination of both based on processing signals from the Bluetooth sensors to cause coupling of the target area with the feeder house with central axis alignment maintained between the opening of the feeder house and the central opening of the header.

16. The system of claim 13, wherein the control system comprises one or more cameras mounted to the combine harvester and configured to enable identification of features associated with the header, the control system further configured to guide movement of the combine harvester, the feeder house, or a combination of both based on processing signals from the one or more cameras to cause attachment of the target area with the feeder house with central axis alignment maintained between the opening of the feeder house and the central opening of the header.

17. The system of claim 13, further comprising a sensor mounted to the combine harvester and configured to provide a feedback signal to the control system that confirms the automated coupling of the feeder house to the header.

18. The system of claim 11, wherein the control system comprises a user interface configured to receive operator input, wherein responsive to the operator input, the control system causes the automated alignment and coupling.

19. The system of claim 11, further comprising a sensor located in a cab of the combine harvester, the sensor signaling to the control system whether the cab is occupied by an operator, wherein the automated alignment and coupling is implemented based on the sensor signaling occupancy in the cab by the operator.

20. (canceled)

21. The system of claim 11, wherein the feeder house includes a lateral tilt assembly that surrounds a front face of the feeder house, and wherein the lateral tilt assembly is moveable about a pivot axis, and wherein the control system is configured to cause pivoting movement of the lateral tilt assembly around the pivot axis when aligning the feeder house with the target area.
